(19) United States
(12) Patent Application Publication
(10) Pub. No.: US 2025/0013250 A1
(43) Pub. Date: Jan. 9, 2025

(54) UNMANNED VEHICLE SYSTEM

(71) Applicant: Qisda Corporation, Taoyuan City (TW)

(72) Inventors: Chao-Shun Yu, Taoyuan City (TW); Wen-Chang Chen, Taoyuan City (TW); Chun-Sheng Hu, Taoyuan City (TW)

(73) Assignee: Qisda Corporation, Taoyuan City (TW)

(21) Appl. No.: 18/643,998

(22) Filed: Apr. 23, 2024

(30) Foreign Application Priority Data
Jul. 4, 2023 (TW) 112124834

(51) Int. Cl. G05D 1/698; G05D 1/247; G05D 109/25; G05D 111/10

(52) U.S. Cl. CPC G05D 1/6983; G05D 1/247; G05D 2109/254; G05D 2111/14

(57) ABSTRACT

Embodiments of the disclosure provide an unmanned vehicle system, including a plurality of unmanned vehicles. The plurality of unmanned vehicles include a first unmanned vehicle and a second unmanned vehicle. The first unmanned vehicle provides an information pattern, wherein the information pattern indicates a control information. The second unmanned vehicle acquires the control information by identifying the information pattern.

### CROSS-REFERENCE TO RELATED APPLICATION

This application claims the priority benefit of Taiwan application serial no. 112124834, filed on Jul. 4, 2023. The entirety of the above-mentioned patent application is hereby incorporated by reference herein and made a part of this specification.

### BACKGROUND

### Technical Field

The disclosure relates to a vehicle technology, and in particular relates to an unmanned vehicle system.

### Description of Related Art

In most unmanned vehicle control systems, communication is typically achieved through a central server interacting with multiple unmanned vehicles. Each unmanned vehicle needs to be connected to this central server through wireless or wired means to undertake the tasks assigned by the central server.

In the process of arranging tasks, the central server needs to pre-arrange corresponding movement paths according to the tasks of each unmanned vehicle, and the complexity of path planning also increases as the number of unmanned vehicles increases.

In the existing technology, point-to-point communication between unmanned vehicles is mostly implemented based on short-range wireless communication technologies (e.g., Wifi, Bluetooth and/or near field communication (NFC)), and collision prevention mechanisms are mostly implemented with sensors such as acoustic/light radar. However, as the number of unmanned vehicles increases, their related communication mechanisms not only become more complex, but may also cause related radar waves to fill the entire field, affecting the accuracy of control between unmanned vehicles.

### SUMMARY

In view of this, an unmanned vehicle system, which may be configured to solve the above technical problems, is provided in the disclosure.

Embodiments of the disclosure provide an unmanned vehicle system, including multiple unmanned vehicles. The unmanned vehicles include a first unmanned vehicle and a second unmanned vehicle. The first unmanned vehicle provides an information pattern, in which the information pattern indicates a control information. The second unmanned vehicle acquires the control information by identifying the information pattern.

### BRIEF DESCRIPTION OF THE DRAWINGS

FIG. 1 is a schematic diagram of an unmanned vehicle system according to an embodiment of the disclosure.

FIG. 2 is a schematic diagram of a first unmanned vehicle and a second unmanned vehicle according to an embodiment of the disclosure.

FIG. 3 is a schematic diagram of an information transmission mechanism according to an embodiment of the disclosure.

### DETAILED DESCRIPTION OF DISCLOSED EMBODIMENTS

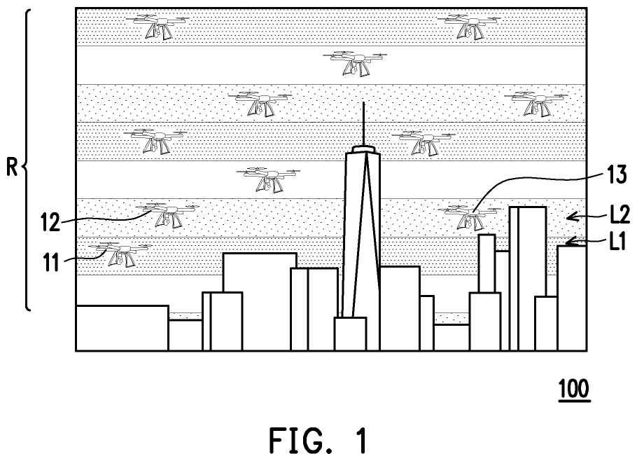

Referring to FIG. 1, FIG. 1 is a schematic diagram of an unmanned vehicle system according to an embodiment of the disclosure. In an embodiment of the disclosure, the unmanned vehicle system 100 includes multiple unmanned vehicles, in which the multiple unmanned vehicles are, for example, drones, but not limited thereto. In other embodiments, the unmanned vehicle system 100 may also include multiple unmanned transport vehicles, autonomous mobile robots, or the like, but not limited thereto.

In one embodiment, the unmanned vehicles are, for example, drones distributed in a working range R (e.g., airspace or other similar fields), and this working range R may be divided into, for example, multiple working layers.

In the scenario of FIG. 1, each unmanned vehicle may, for example, be assigned to move/work in one of the working layers. For example, the unmanned vehicle 11 may be assigned to move and/or perform tasks in the working layer L1, and the unmanned vehicles 12 and 13 may be assigned to move and/or perform tasks in the working layer L2, but not limited thereto.

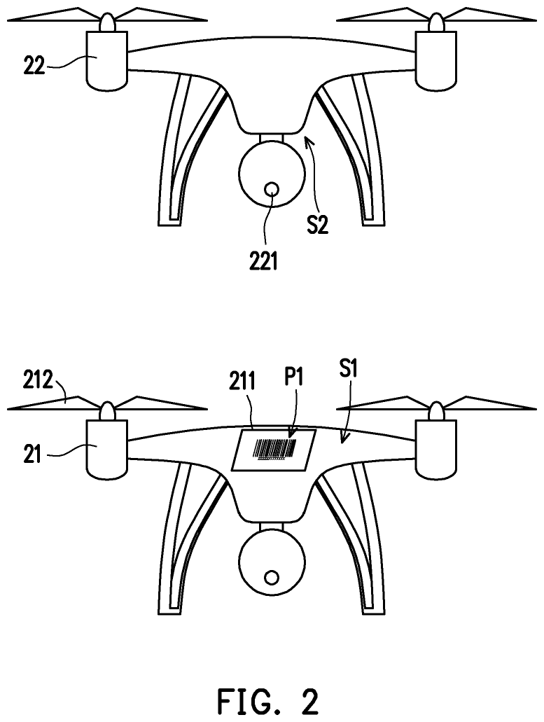

In embodiments of the disclosure, one unmanned vehicle may transmit information to another unmanned vehicle in a specific manner. To facilitate understanding, the relevant description is supplemented by taking FIG. 2 as an example, but this is only used as an example and is not intended to limit the possible implementations of the disclosure.

Referring to FIG. 2, FIG. 2 is a schematic diagram of a first unmanned vehicle and a second unmanned vehicle according to an embodiment of the disclosure. In this embodiment, the first unmanned vehicle 21 and the second unmanned vehicle 22 are, for example, two unmanned vehicles in the unmanned vehicle system 100 in FIG. 1, but not limited thereto.

In FIG. 2, the first unmanned vehicle 21 may include, for example, a display device 211 installed on the first surface S1 (e.g., the top surface) of the first unmanned vehicle 21. In different embodiments, the display device 211 may be implemented as various displays/screens, such as liquid crystal displays (LCD), plasma displays, vacuum fluorescent displays, light-emitting diodes (LED) displays, field emission displays (FED), electronic paper screen, etc., but may not be limited thereto.

In one embodiment, the display device 211 may also be implemented as an LED rotating display system including multiple light-emitting diode (LED) light bars. In one embodiment, the LED rotating display system may be independently disposed on the first surface S1 of the first unmanned vehicle 21, or integrated with the propeller 212 of the first unmanned vehicle 21, utilizing the rotating LED light bars to display patterns, and then forming graphics, animations, etc., by using the principle of visual persistence, but not limited thereto.

In one embodiment, the display device 211 may be configured to provide/display the information pattern P1, and the information pattern P1 can, for example, indicate control information (hereinafter referred to as CI). In the scenario of FIG. 2, the information pattern P1 may be implemented as, for example, a barcode. In other embodiments, the information pattern P1 may also be implemented as a QR code and/or other patterns that may be configured to carry information, but not limited thereto.

In the unmanned vehicle system 100, unmanned vehicles other than the first unmanned vehicle 21 may acquire the control information CI by identifying the information pattern P1, and perform corresponding tasks accordingly. For ease of understanding, the second unmanned vehicle 22 is taken as an example for description below, but the disclosure may not be limited thereto.

In FIG. 2, the second unmanned vehicle 22 may include a reader 221, and the reader 221 can, for example, be installed on the second surface S2 (e.g., the bottom surface) of the second unmanned vehicle 22 and read the information pattern P1. In this case, the first unmanned vehicle 21 may be understood as providing/displaying the information pattern P1 upward, and the second unmanned vehicle 22 may be understood as reading the information pattern P1 downward.

In other embodiments, the first surface S1 of the first unmanned vehicle 21 may also be the bottom surface of the first unmanned vehicle 21. Correspondingly, the second surface S2 of the second unmanned vehicle 22 may be implemented as the top surface of the second unmanned vehicle 22. In this case, the first unmanned vehicle 21 may be understood as providing/displaying the information pattern P1 downward, and the second unmanned vehicle 22 may be understood as reading the information pattern P1 upward, but not limited thereto.

In different embodiments, the reader 221 may be implemented as a barcode reader, a QR code reader, and/or other reading devices that may be configured to read/identify the information pattern P1, but limited thereto.

In some embodiments, the control information CI may be configured, for example, to enable one or more unmanned vehicles that acquire the control information CI to perform (or stop performing) a specific task.

For example, it is assumed that the second unmanned vehicle 22 is located in a specific working layer (e.g., working layer L2) within the working range R in FIG. 1, and the control information CI can, for example, control the second unmanned vehicle 22 to move from its specific working layer to another specific working layer (e.g., working layer L1) within the working range R.

As another example, the control information CI may control the second unmanned vehicle 22 to suspend the first task currently being performed (e.g., emitting light in place) and start performing a second task (e.g., rotating while moving).

As another example, the control information CI can, for example, control the second unmanned vehicle 22 to suspend going to a specific working region. For example, it is assumed that the task currently being performed by the second unmanned vehicle 22 is to go to the working layer L1, but if congestion has already occurred in the working layer L1 (e.g., too many unmanned vehicles already exist), the first unmanned vehicle 21 may control the second unmanned vehicle 22 through control information CI to temporarily stop heading to the working layer L1, in order to avoid increasing the congestion level of the working layer L1, but not limited thereto.

In the scenario of FIG. 2, assuming that the first unmanned vehicle 21 is located in a certain working layer (e.g., working layer L1) within the working range R, then unmanned vehicles located in other working layers (e.g., working layer L2) above this working layer may acquire the control information CI by reading the information pattern P1.

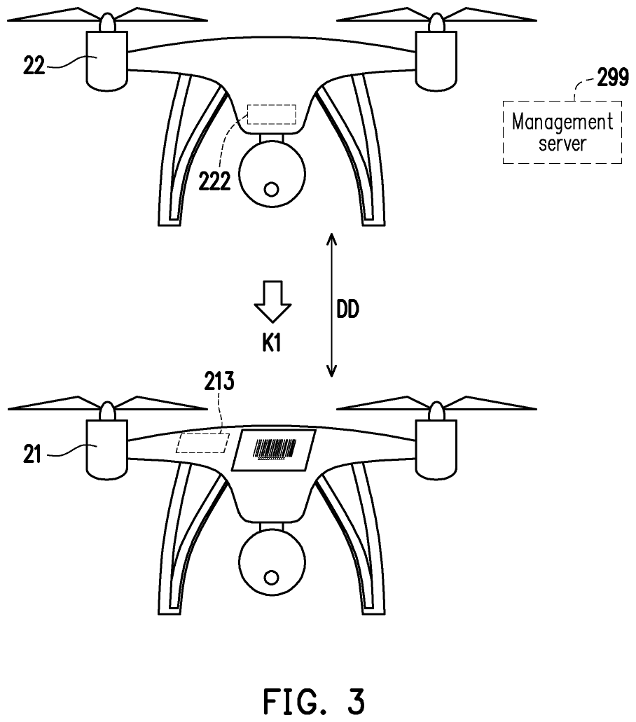

In one embodiment, in addition to transmitting the control information CI from the first unmanned vehicle 21 to the second unmanned vehicle 22 in the manner shown in FIG. 2, the second unmanned vehicle 22 may also transmit information to the first unmanned vehicle 21 in a specific manner, and the relevant content is explained with the help of FIG. 3.

Referring to FIG. 3, FIG. 3 is a schematic diagram of an information transmission mechanism according to an embodiment of the disclosure. In FIG. 3, in order for the second unmanned vehicle 22 to detect objects below it, the second unmanned vehicle 22 (the second surface S2 thereof) may be provided with a second infrared transceiver 222. This allows it to estimate distance and other information based on the infrared signal reflected after the emission of an infrared signal.

In embodiments of the disclosure, the second unmanned vehicle 22 may be configured to provide additional information to another unmanned vehicle (e.g., the first unmanned vehicle 21) through the infrared signal emitted by the second infrared transceiver 222.

In this case, the first unmanned vehicle 21 (the first surface S1 thereof) may be provided with a first infrared transceiver 213, and the first infrared transceiver 213 may receive the specific infrared signal K1 sent by the second unmanned vehicle 22 through the second infrared transceiver 222.

In one embodiment, the second unmanned vehicle 22 may carry relevant information about the specific working layer where the second unmanned vehicle 22 is located in the specific infrared signal K1 that is sent. For example, assuming that the second unmanned vehicle 22 is currently located at the working layer L2, the second unmanned vehicle 22 may include a working layer indicator that may indicate the working layer L2 in the specific infrared signal K1 that is sent.

Correspondingly, after the first unmanned vehicle 21 receives the specific infrared signal K1 through the first infrared transceiver 213, it may be acquired that the second unmanned vehicle 22 is currently located at the working layer L2, but not limited thereto.

In addition, in the scenario of FIG. 3, assuming that the first unmanned vehicle 21 is located on a certain working layer in the working range R, the first unmanned vehicle 21 may receive corresponding specific infrared signals from unmanned vehicles located in other working layers (e.g., the working layer L2) above the working layer through the above manner. For example, assuming that the first unmanned vehicle 21 is located on the working layer L1, the first unmanned vehicle 21 may acquire how many unmanned vehicles there are in each working layer above the working layer L1 through the above manner.

For example, it is assumed that the first unmanned vehicle 21 receives a total of K (K is a positive integer) specific infrared signals corresponding to different unmanned vehicles, and the K specific infrared signals all include working layer indicators corresponding to the working layer L2. In this case, the first unmanned vehicle 21 may determine that at least K unmanned vehicles are working/moving in the working layer L2, but not limited thereto.

In one embodiment, the first unmanned vehicle 21 may also acquire the received power of the first infrared transceiver 213 when receiving the specific infrared signal K1, and estimate the specific distance DD between the first unmanned vehicle 21 and the second unmanned vehicle 22 accordingly. Afterwards, the first unmanned vehicle 21 may determine the specific working layer where the second unmanned vehicle 22 is located based on the specific distance DD.

Generally speaking, the attenuation degree of signal is inversely proportional to distance. In this case, assuming that the first unmanned vehicle 21 knows the power of the specific infrared signal K1 emitted by the second unmanned vehicle 22, the first unmanned vehicle 21 can, for example, infer the specific distance DD based on the attenuation degree of the received power of the specific infrared signal K1.

Upon learning that the second unmanned vehicle 22 is located above the first unmanned vehicle 21 and is at a specific distance DD, the first unmanned vehicle 21 may accordingly determine which working layer in the working range R the second unmanned vehicle 22 should currently be located in. For example, assuming that the range of the working layer L2 is from A meters to B meters above sea level, the first unmanned vehicle 21 may add its own height to a specific distance DD to acquire the height of the second unmanned vehicle 22. Assuming that the height of the second unmanned vehicle 22 is between A meters and B meters above sea level, the first unmanned vehicle 21 may determine that the second unmanned vehicle 22 is located in the working layer L2, but not limited thereto.

In addition, in the scenario of FIG. 3, assuming that the first unmanned vehicle 21 is located on a certain working layer in the working range R, the first unmanned vehicle 21 may receive corresponding specific infrared signals from unmanned vehicles located in other working layers (e.g., the working layer L2) above the working layer through the above manner, and determine the working layer where these unmanned vehicles are located accordingly. For related details, reference may be made to the description of the aforementioned embodiments, which are not repeated herein.

In one embodiment, the first unmanned vehicle 21 may determine the number of unmanned vehicles corresponding to each working layer according to the above method, and report the number of unmanned vehicles corresponding to each working layer to the management server 299. In the embodiment of the disclosure, the management server 299 is, for example, a server configured to arrange/control each unmanned vehicle in the unmanned vehicle system 100, but not limited thereto.

In one embodiment, the first unmanned vehicle 21 may receive wireless signals from each unmanned vehicle located on each working floor (e.g., a specific infrared signal corresponding to each unmanned vehicle), and determine the number of unmanned vehicles corresponding to each working layer accordingly.

In another embodiment, the first unmanned vehicle 21 may also take multiple images of each unmanned vehicle located on each working layer, and determine the number of unmanned vehicles corresponding to each working layer accordingly. For example, the first unmanned vehicle 21 may perform relevant image recognition on the unmanned vehicles in the captured images to estimate the distance between each unmanned vehicle and the first unmanned vehicle 21 based on, for example, the size of each unmanned vehicle in the image. Afterwards, the first unmanned vehicle 21 may infer the working layer where each unmanned vehicle is located based on the previous description, and report it to the management server 299 accordingly, but not limited thereto.

In one embodiment, the first unmanned vehicle 21 may also determine the number of unmanned vehicles corresponding to the sub-working range within the working range R according to the number of received wireless signals after receiving wireless signals (e.g., the aforementioned specific infrared signals) from unmanned vehicles located at each working layer, in which the sub-working range includes at least one of the multiple working layers.

For example, assuming that the first unmanned vehicle 21 located on the working layer L1 receives K wireless signals from above it, the first unmanned vehicle 21 may determine one or more working layers above the working layer L1 as a sub-working range of the working range R, and accordingly determine that there are K unmanned vehicles in this sub-working range, but not limited thereto.

In one embodiment, the unmanned vehicle system 100 may include at least one relay vehicle and at least one other vehicle, and in the unmanned vehicle system 100, only the relay vehicle is allowed to communicate with the management server 299, and the other vehicles are not allowed to communicate with the management server 299. In other words, in the unmanned vehicle system 100, only relay vehicles may communicate with the management server 299, and other vehicles that are not relay vehicles cannot communicate with the management server 299.

In the embodiment of the disclosure, each relay vehicle may acquire at least one of the information pattern P1 and the control information CI from the management server 299. Afterwards, each relay vehicle may transmit the information pattern P1 and/or control information CI to other unmanned vehicles in the manner shown in FIG. 2. In other words, the management server 299 may transmit the information pattern P1 and/or the control information CI to other vehicles through the relay vehicle while only communicating with the relay vehicle. In this way, the communication burden and complexity of the management server 299 may be effectively reduced.

It is assumed that the first unmanned vehicle 21 belongs to the above-mentioned relay vehicle, and the second unmanned vehicle 22 belongs to the above-mentioned other vehicles. In this case, after acquiring the information pattern P1 and/or control information CI from the management server 299, the first unmanned vehicle 21 may transmit the information pattern P1 and/or control information CI to the second unmanned vehicle 22 and other unmanned vehicles belonging to other vehicles that are unable to communicate with the management server 299 through the mechanism shown in FIG. 2. In this way, the management server 299 may transmit the information pattern P1 and/or the control information CI to the second unmanned vehicle 22 through the first unmanned vehicle 21 without communicating with the second unmanned vehicle 22 and other unmanned vehicles belonging to other vehicles.

In summary, in this embodiment of the disclosure, the second unmanned vehicle may acquire the control information indicated by the information pattern by identifying the information pattern provided by the first unmanned vehicle, and perform the corresponding tasks/operations accordingly. In this way, the management server may transmit information patterns and/or control information to the second unmanned vehicle through the first unmanned vehicle without the need for communication with the second unmanned vehicle, thereby effectively reducing the communication burden and complexity of the management server.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. An unmanned vehicle system, comprising:
a plurality of unmanned vehicles, comprising:
a first unmanned vehicle, providing an information pattern, wherein the information pattern indicates a control information; and
a second unmanned vehicle, acquiring the control information by identifying the information pattern.

2. The unmanned vehicle system according to claim 1, wherein the first unmanned vehicle comprises a display device, and the display device displays the information pattern.

3. The unmanned vehicle system according to claim 2, wherein the display device comprises at least one of a screen and a light-emitting diode rotating display system.

4. The unmanned vehicle system according to claim 3, wherein the first unmanned vehicle comprises a propeller, and the light-emitting diode rotating display system is integrated with the propeller.

5. The unmanned vehicle system according to claim 2, wherein the display device is installed on a first surface of the first unmanned vehicle, the second unmanned vehicle comprises a reader, the reader is installed on a second surface of the second unmanned vehicle and reads the information pattern.

6. The unmanned vehicle system according to claim 5, wherein the first unmanned vehicle and the second unmanned vehicle respectively are a first drone and a second drone, and the first surface is one of a top surface and a bottom surface, the second surface is another one of the top surface and the bottom surface.

7. The unmanned vehicle system according to claim 1, wherein the first unmanned vehicle comprises a first infrared transceiver, the second unmanned vehicle comprises a second infrared transceiver, wherein the first infrared transceiver receives a specific infrared signal sent by the second unmanned vehicle through the second infrared transceiver.

8. The unmanned vehicle system according to claim 7, wherein the first unmanned vehicle and the second unmanned vehicle are distributed in a working range divided into a plurality of working layers, and the first unmanned vehicle determines a specific working layer where the second unmanned vehicle is located based on the specific infrared signal from the second infrared transceiver, wherein the specific working layer is one of the working layers.

9. The unmanned vehicle system according to claim 8, wherein the specific infrared signal from the second infrared comprises a working layer indicator, wherein the working layer indicator indicates the specific working layer where the second unmanned vehicle is located.

10. The unmanned vehicle system according to claim 8, wherein the first unmanned vehicle performs:
acquiring a received power of the specific infrared signal received by the first infrared transceiver, and estimating a specific distance between the first unmanned vehicle and the second unmanned vehicle accordingly;
determining the specific working layer where the second unmanned vehicle is located based on the specific distance.

11. The unmanned vehicle system according to claim 1, wherein the unmanned vehicles are distributed in a working range divided into a plurality of working layers, and the first unmanned vehicle performs:
determining a number of unmanned vehicles corresponding to each of the working layers; and
reporting the number of unmanned vehicles corresponding to each of the working layers to a management server.

12. The unmanned vehicle system according to claim 11, wherein the first unmanned vehicle performs:
receiving a wireless signal from each of the unmanned vehicles located at each of the working layers, and determining the number of unmanned vehicles corresponding to each of the working layers accordingly.

13. The unmanned vehicle system according to claim 11, wherein the first unmanned vehicle performs:
taking a plurality of images of each of the unmanned vehicles located at each of the working layers, and determining the number of unmanned vehicles corresponding to each of the working layers accordingly.

14. The unmanned vehicle system according to claim 1, wherein the unmanned vehicles are distributed in a working range divided into a plurality of working layers, and the first unmanned vehicle performs:
receiving a wireless signal from each of the unmanned vehicles located at each of the working layer; and
determining a number of unmanned vehicles corresponding to a sub-working range in the working range according to the number of received wireless signals, wherein the sub-working range comprises at least one of the working layers.

15. The unmanned vehicle system according to claim 1, wherein the information pattern comprises at least one of a QR code and a barcode.

16. The unmanned vehicle system according to claim 1, wherein the unmanned vehicles comprise at least one relay vehicle and at least one other vehicle, and only the at least one relay vehicle among the unmanned vehicles is allowed to communicate with a management server, the at least one other vehicle is not allowed to communicate with the management server, wherein the first unmanned vehicle serves as one of the at least one relay vehicle and acquires at least one of the information pattern and the control information from the management server.

17. The unmanned vehicle system according to claim 1, wherein the unmanned vehicles are distributed in a working range divided into a plurality of working layers, the second unmanned vehicle is located in a specific working layer among the working layers, and the control information controls the second unmanned vehicle to move from the specific working layer where the second unmanned vehicle is located to another specific working layer among the working layers.

18. The unmanned vehicle system according to claim 1, wherein the control information controls the second unmanned vehicle to suspend a first task and start performing a second task.

19. The unmanned vehicle system according to claim 1, wherein the control information controls the second unmanned vehicle to suspend going to a specific working region.
